(19) United States
(12) Patent Application Publication
(10) Pub. No.: US 2026/0087566 A1
(43) Pub. Date: Mar. 26, 2026

(54) ENERGY-SAVING INFORMATION PROVIDING APPARATUS AND METHOD

(71) Applicant: INSTITUTE FOR INFORMATION INDUSTRY, TAIPEI (TW)

(72) Inventors: Su An LIU, Taipei (TW); Kuei Chun CHIANG, Taipei (TW); Yung Chieh HUNG, Taipei (TW)

(21) Appl. No.: 18/937,032

(22) Filed: Nov. 5, 2024

(30) Foreign Application Priority Data
Sep. 23, 2024 (CN) 202411324116.0

(51) Int. Cl. G06Q 50/06

(52) U.S. Cl. CPC G06Q 50/06

(57) ABSTRACT

An energy-saving information providing apparatus and method are provided. The apparatus stores a plurality of pieces of energy-saving information. The apparatus assigns a user level to a user account based on a feedback record of the user account. The apparatus groups the user account into a first energy usage type of a plurality of energy usage types based on an energy usage record of the user account. The apparatus selects at least one similar account from a plurality of accounts based on the first energy usage type. The apparatus selects a recommended energy-saving information from the energy-saving information based on the user level of the user account and at least one feedback record of the at least one similar account, and sends the recommended energy-saving information to the user account.

### CROSS-REFERENCE TO RELATED APPLICATION

This application claims priority to China Application Serial Number 202411324116.0, filed September 23, 2024, which is herein incorporated by reference in its entirety.

### BACKGROUND

### FIELD OF INVENTION

The present disclosure relates to energy-saving information providing apparatus and method. More particularly, the present disclosure relates to energy-saving information providing apparatus and method based on electric usage records.

### DESCRIPTION OF RELATED ART

With the rise of environmental awareness, reducing energy waste has become a key issue. To promote environmental protection, the governments and power companies disseminate energy-saving information to the public in many ways.

However, when energy-saving information is disseminated without considering the power consumption type of the user, the provided content may be inaccurate and inconsistent with the user's actual daily usage scenarios. Thus discrepancy can make it more difficult for users to implement suggested energy-saving measures effectively and accordingly.

In light of these challenges, there is a growing need in the industry to disseminate energy-saving information more accurately, tailored to each user’s specific power consumption habits.

### SUMMARY

The disclosure provides an energy-saving information providing apparatus comprising a storage and a processor. The storage is configured to store a plurality of pieces of energy-saving information. The processor is coupled to the storage and configured to execute the following operations: assigning a user level to a user account based on a feedback record of the user account, wherein the feedback record of the user account corresponds to the energy-saving information; grouping the user account into a first energy usage type among a plurality of energy usage types based on an energy usage record of the user account; selecting at least one similar account from a plurality of accounts based on the first energy usage type; and selecting a piece of recommended energy-saving information from the energy-saving information based on the user level of the user account and at least one feedback record of the at least one similar account and sending the recommended energy-saving information to the user account.

The disclosure further provides an energy-saving information providing method, adapted for use in an electronic apparatus, wherein the energy-saving information providing method comprises the following steps: obtaining a plurality of pieces of energy-saving information; assigning a user level to a user account based on a feedback record of the user account, wherein the feedback record of the user account corresponds to the energy-saving information; grouping the user account into a first energy usage type among a plurality of energy usage types based on an energy usage record of the user account; selecting at least one similar account from a plurality of accounts based on the first energy usage type; and selecting a piece of recommended energy-saving information from the energy-saving information based on the user level of the user account and at least one feedback record of the at least one similar account and sending the recommended energy-saving information to the user account.

It is understood that both the foregoing general description and the following detailed description are provided as examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an energy-saving information providing apparatus according to a first embodiment of the present disclosure.

FIG. 2 is a schematic diagram illustrating the energy-saving information providing apparatus generating recommended energy-saving information according to some embodiments of the present disclosure.

FIG. 3 is a schematic diagram illustrating the energy-saving information providing apparatus obtaining energy-saving information according to some embodiments of the present disclosure.

FIG. 4 is a schematic diagram illustrating the energy-saving information providing apparatus generating feature groups based on energy usage records according to some embodiments of the present disclosure.

FIG. 5 is a flow diagram illustrating an energy-saving information providing method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

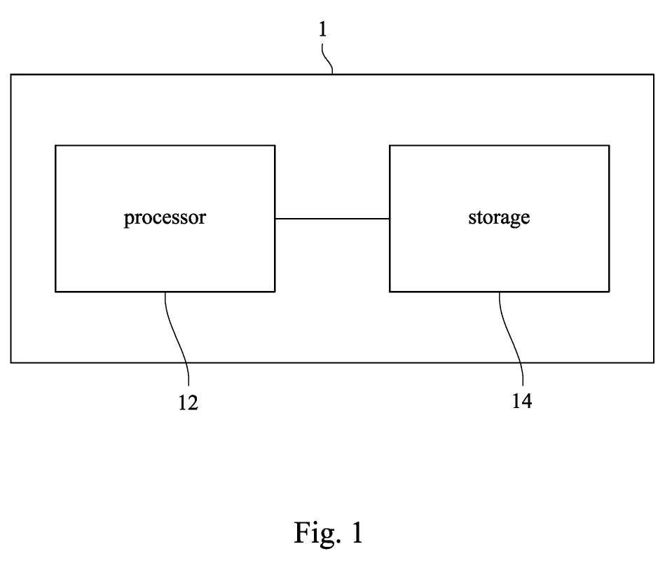

Please refer to FIG. 1, which is a schematic diagram illustrating an energy-saving information providing apparatus 1 according to a first embodiment of the present disclosure. The energy-saving information providing apparatus 1 comprises a processor 12 and a storage 14, wherein the processor 12 electrically connected to the storage 14. The energy-saving information providing apparatus 1 is configured to send recommended energy-saving information based on energy usage records and feedback from a user account.

In some embodiments, the energy-saving information providing apparatus 1 is a server, whereby the server sends the energy-saving information to the apparatus corresponding to the user account (e.g., mobile phone, personal computer) via network or other communication interface. In some embodiments, the energy-saving information providing apparatus 1 is the apparatus corresponding to the user account, and the apparatus sends the energy-saving information to the user account directly.

In some embodiments, the processor 12 comprises a central processing unit (CPU), a graphics processing unit (GPU), a multi-processor, a distributed processing system, an application specific integrated circuit (ASIC), and/or another suitable processing unit.

The storage 14 is configured to store a plurality of pieces of energy-saving information, wherein the energy-saving information comprises energy-saving knowledge for the user account to provide the user tips for saving energy.

For example, the energy-saving information comprises information of reminder category, behavior category, and equipment category. The energy-saving information within the reminder category comprises information contain suggestions for reminding the user to reduce power waste, such as “Remember to turn off the light after leaving the room.” The energy-saving information within behavior category comprises information providing suggestions for adjusting energy usage behavior, such as “Turning on sleep mode and setting a timer of the air conditioner can reduce energy consumption.” The energy-saving information in the equipment category comprises suggestions or tips for the maintenance and installation of electrical equipment, such as “Defrosting the refrigerator regularly to maintain higher efficiency.”

In some embodiments, the storage 14 comprises a semiconductor or solid-state memory, a magnetic tape, a removable computer diskette, a random-access memory (RAM), a read-only memory (ROM), a rigid magnetic disk, and/or an optical disk.

In order to select suitable information for sending to the user account from the energy-saving information, the energy-saving information providing apparatus 1 determines the energy usage scenario based on feedback from the user account and selects similar accounts based on the energy usage record of the user account. Finally, the energy-saving information providing apparatus 1 selects recommended energy-saving information based on the energy usage of the user account and the similar account and sends the information to the user account.

Specifically, the processor 12 executes the following operations: assigning a user level to a user account based on a feedback record of the user account, wherein the feedback record of the user account corresponds to the energy-saving information; grouping the user account into a first energy usage type from a plurality of energy usage types based on an energy usage record of the user account; selecting at least one similar account from a plurality of accounts based on the first energy usage type; and selecting a piece of recommended energy-saving information from the energy-saving information based on the user level of the user account and at least one feedback record of the at least one similar account and sending the recommended energy-saving information to the user account.

It is noted that, the accounts record the energy usage record and interaction data with the energy-saving information providing apparatus 1 of the corresponding energy user, wherein the user account is the account registered by the user of the energy-saving information providing apparatus 1.

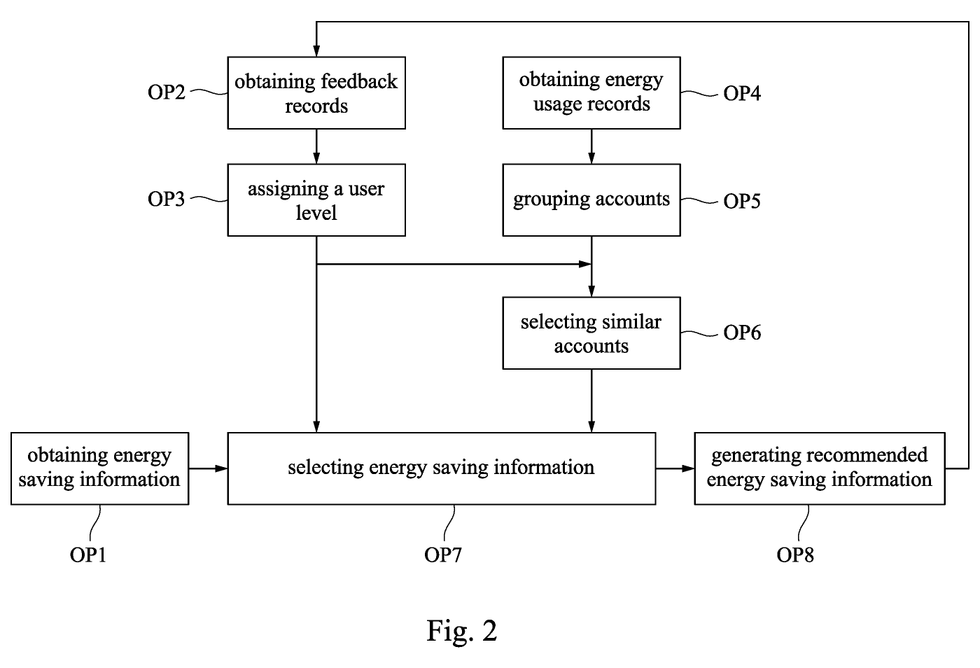

For details regarding the energy-saving information providing apparatus 1 generating the recommended energy-saving information, please refer to FIG. 2, which is a schematic diagram illustrating the energy-saving information providing apparatus 1 generating recommended energy-saving information according to some embodiments of the present disclosure.

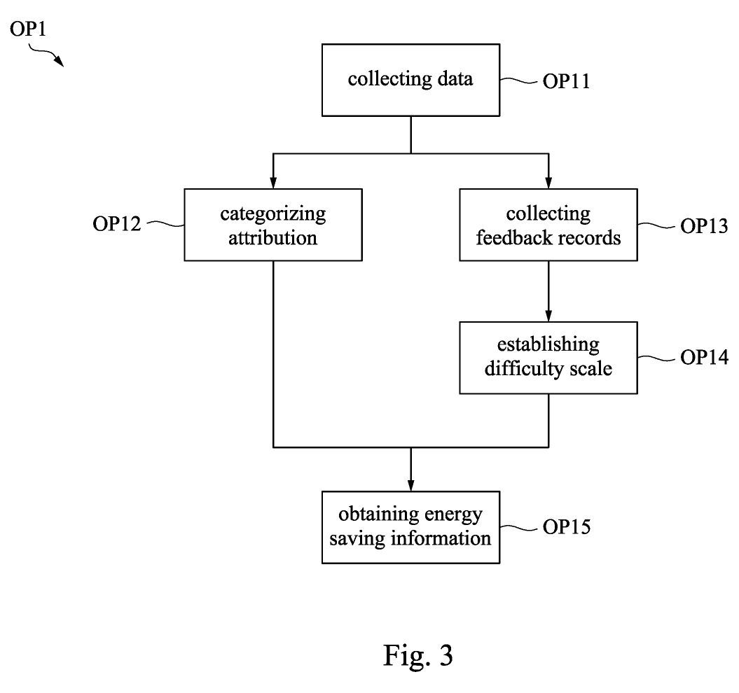

In the operation OP1, the energy-saving information providing apparatus 1 obtains energy-saving information and stores the energy-saving information into the storage 14. For further details regarding the energy-saving information providing apparatus 1 obtaining the energy-saving information, please refer to FIG. 3, the operation OP1 further comprises operations OP11-OP15.

First, in the operation OP11, the energy-saving information providing apparatus 1 collects data related to the energy-saving information. In some embodiments, the energy-saving information may be obtained through searching methods such as retrieving related documents, web crawling by the energy-saving information providing apparatus 1.

Furthermore, in the operation OP12, the energy-saving information providing apparatus 1 categorizes the energy-saving information according to its attributes.

In some embodiments, the energy-saving information providing apparatus 1 labels the energy-saving information by attributes. For example, the energy-saving information related to specific electrical appliance is labeled by the energy-saving information providing apparatus 1 according to the keywords in the energy-saving information, for example, refrigerator, air conditioner, dehumidifier, etc.

On the other hand, in the operation OP13, the energy-saving information providing apparatus 1 collects feedback records from the accounts to evaluate the energy-saving information. For example, the energy-saving information providing apparatus 1 creates a questionnaire by using the energy-saving information collected and provides the questionnaire to multiple accounts to investigate whether the users have implemented the energy-saving behaviors corresponding to the energy-saving information.

Based on the evaluation results from the operation OP13, in the operation OP14, the energy-saving information providing apparatus 1 establishes a difficulty scale for the energy-saving information. For example, the greater the number of accounts implementing the energy-saving behavior, the lower the corresponding difficulty level; and the fewer accounts implementing the energy-saving behavior, the higher the corresponding difficulty level. In some embodiments, the difficulty levels are represented by numerical values between 0-6 and divided into 6 levels according to the numerical values. Lower difficulty levels indicate easier implementation difficulty of the energy-saving information, and higher difficulty levels indicate greater implementation difficulty of the energy-saving information.

After categorizing the energy-saving information and establishing the difficulty scale, in the operation OP15, the energy-saving information providing apparatus 1 obtains the pre-processed energy-saving information.

Please return to FIG. 2, on the other hand, in the operation OP2, the energy-saving information providing apparatus 1 obtains a feedback record for the user account. For example, the energy-saving information providing apparatus 1 provides a questionnaire to the user, with questions about which electrical appliances the user utilizes and whether the user implements certain energy-saving behaviors, etc.

In some embodiments, the questionnaire in the operation OP2 may comprise the questionnaire in the operation OP13. Accordingly, the energy-saving information providing apparatus 1 is able to confirm which pieces of the energy-saving information has been implemented by the user via the questionnaire and can avoid sending the corresponding energy-saving information to the user account in the future.

After obtaining the feedback record for the user account, the energy-saving information providing apparatus 1 executes the operation OP3, assigning a user level to the user account, wherein the user level represents the user’s willingness to implement the energy-saving behaviors.

In some embodiments, the feedback record for the user account comprises at least one piece of information implemented by the user account from the energy-saving information. The operation of the processor 12 assigning the user level to the user account further comprises: calculating a score for the user account based on at least one difficulty level corresponding to the implemented information; and determining the user level of the user account based on the score.

For example, the energy-saving information providing apparatus 1 assigns a corresponding weight to each piece of the energy-saving information according to the difficulty scale established in the operation OP14. When the user account implements an energy-saving behavior corresponding to a higher weight (i.e., higher difficulty level), the energy-saving information providing apparatus 1 assigns a higher score to the user account; conversely, when the user account implements an energy-saving behavior corresponding to a lower weight (i.e., lower difficulty level), the energy-saving information providing apparatus 1 assigns a lower score to the user account; and the energy-saving information providing apparatus 1 will not assign scores for the unimplemented energy-saving behavior.

Therefore, according to the feedback record for the user account, the energy-saving information providing apparatus 1 is able to calculate the user level of the user account. The user level represents the capacity of the user account of implementing energy-saving behaviors. The higher the level, the greater the number or difficulty of the energy-saving behaviors implemented.

In some embodiments, since the user level is calculated based on the difficulty levels of the energy-saving information, the user level may also be represented by the same scale. For example, the difficulty levels and the user level are represented by numerical values between 0-6 and divided into 6 levels according to the numerical values.

On the other hand, in the operation OP4, the energy-saving information providing apparatus 1 obtains an energy usage record of the user account. For example, the energy-saving information providing apparatus 1 obtains the electric consumption at multiple time points from the electric meter of the user account’s electric meter, e.g., the wattages at multiple time points and/or electric consumption (kW/hr) over multiple time intervals.

Furthermore, in the operation OP5, the energy-saving information providing apparatus 1 groups the user account into at least one energy usage type based on the energy usage record of the user account, wherein the energy usage type indicates the energy consumption trend of the user account.

For example, the energy-saving information providing apparatus 1 collects energy usage records of multiple accounts and groups the accounts based on the energy consumption and/or the energy consumption trend over time to generate multiple energy usage types. Accordingly, after obtaining the energy usage record of the user account, the energy-saving information providing apparatus 1 may group the user account into one of the energy usage types.

In some embodiments, the energy-saving information providing apparatus 1 first groups the accounts into a high energy usage group and a low energy usage group based on energy consumptions, then the energy-saving information providing apparatus 1 groups the accounts in the two energy usage groups respectively according to energy usage features to generate the energy usage types and groups the user account accordingly.

Specifically, the operation of the processor 12 grouping the user account into the first energy usage type further comprises: selecting a first energy usage group from a plurality of energy usage groups based on a total energy consumption of the user account; and grouping the user account into the first energy usage type based on a plurality of energy consumptions of the user account corresponding to a plurality of time points, wherein the first energy usage type corresponding to the first energy usage group.

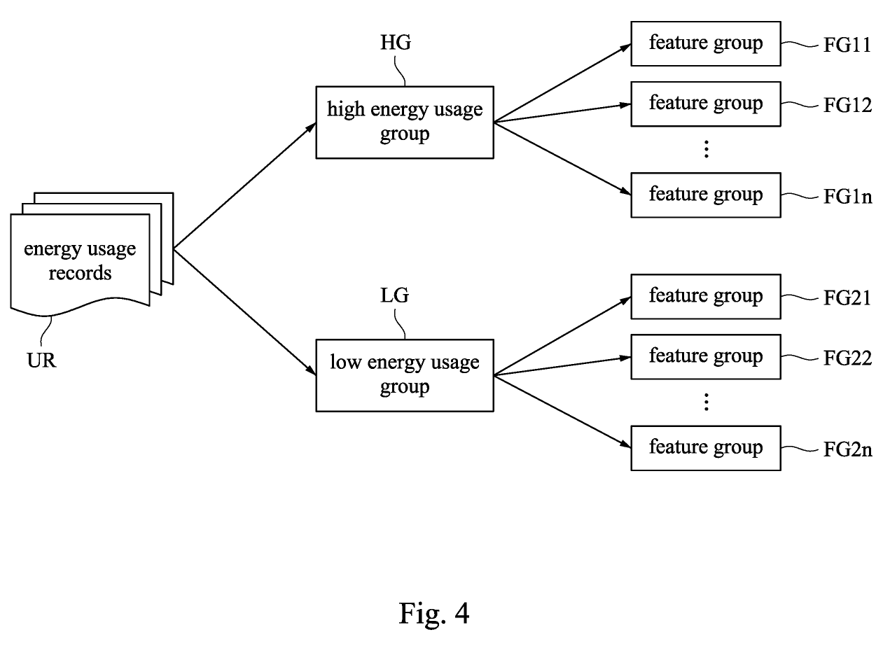

For further details of the embodiment, please refer to FIG. 4, which is a schematic diagram illustrating the energy-saving information providing apparatus 1 generating feature groups based on energy usage records according to some embodiments of the present disclosure.

As shown in the figure, the energy-saving information providing apparatus 1 groups an account into one of a high energy usage group HG and a low energy usage group LG based on multiple energy usage records UR of the account, wherein the grouping criteria may include total electric consumption and/or the peak electric consumption within a given time interval, e.g., total weekly electric consumption, monthly consumption, and/or peak daily electric consumption.

Specifically, the operation of the processor 12 for selecting the first energy usage group further comprises: grouping both the user account and the accounts into a high energy usage group and a low energy usage group based on the user account’s total energy consumption and a plurality of total energy consumptions of the accounts to generate a first grouping result; and selecting the first energy usage group based on the first grouping result.

Furthermore, the energy-saving information providing apparatus 1 then groups the accounts into one of the feature groups FG11-FG1n or one of the feature groups FG21-FG2n based on the energy usage trends indicated by the energy usage records UR. Noted that the feature groups may also serve as the energy usage groups mentioned above.

Specifically, the operation of the processor 12 grouping the user account into the first energy usage type further comprises: grouping the user account and the accounts within the first energy usage group into a plurality of feature groups based on the energy consumptions of the user account and a plurality of energy consumptions of the accounts within the first energy usage group corresponding to the time points to generate a second grouping result; and selecting the first energy usage type from the energy usage types corresponding to the first energy usage group, based on the second grouping result.

For example, the energy-saving information providing apparatus 1 extracts feature of the electric usage trends of multiple accounts across multiple time intervals based on the electric consumptions corresponding to the time intervals in the energy usage records of the accounts. Accordingly, the energy-saving information providing apparatus 1 groups the accounts to generate n feature groups, wherein n is an integer greater than 1.

It is noticed that, the energy-saving information providing apparatus 1 may group the accounts using a clustering algorithm such as k-means algorithm.

In some embodiments, since the energy usage of an account may vary from day to day, the energy-saving information providing apparatus 1 also groups the daily energy usage record respectively. Accordingly, the energy-saving information providing apparatus 1 is able to capture various energy usage features on different dates. For example, an account A may belong to the feature group FG12 on 5 days of a week and to the feature group FG21 on the remaining 2 days.

For example, the energy-saving information providing apparatus 1 considers the electric usage data (e.g., wattage) sampled every 30 minutes within the energy usage record as a piece of data, thereby collecting a set of 48 pieces of data per day. Furthermore, the energy-saving information providing apparatus 1 groups multiple sets of data of multiple accounts to generate multiple feature groups. Accordingly, the feature groups are able to indicate different daily energy usage trends.

Please return to FIG. 2, in the operation OP6, the energy-saving information providing apparatus 1 selects similar accounts sharing the same energy usage type with the user account based on the grouping result.

As shown in FIG. 2, in some embodiments, the energy-saving information providing apparatus 1 also selects accounts with similar user level among the similar accounts sharing the same energy usage type.

Specifically, the operation of the processor 12 selecting the at least one similar account further comprises: selecting at least one first account corresponding to the first energy usage type from the accounts; and selecting the at least one similar account from the at least one first account based on a level range corresponding to the user level of the user account.

Next, in the operation OP7, the energy-saving information providing apparatus 1 selects the energy-saving information according to the user level of the user account and the feedback record of the similar accounts.

In some embodiments, the energy-saving information providing apparatus 1 selects the energy-saving information with difficulty level similar to the user level of the user account and has been implemented by the similar account to further generate the recommended energy-saving information.

In some embodiments, the energy-saving information providing apparatus 1 selects the energy-saving information has not been implemented by the user account and has been implemented by the similar accounts.

Specifically, the operation of the processor 12 selecting a piece of recommended energy-saving information further comprises: filtering out at least one piece of implemented information already implemented by the user account; and selecting a piece of implemented information from the filtered energy-saving information that at least one similar account has implementedo select the recommended energy-saving information.

In some embodiments, since the difficulty scale established in the operation OP14 is represented by the same scale as the user level, the energy-saving information providing apparatus 1 is able to select the energy-saving information with the difficulty level corresponding to the user level of the user account.

Specifically, the operation of the processor 12 selecting a piece of recommended energy-saving information further comprises: receiving a plurality of feedback records from a plurality of subject accounts, wherein the feedback records of the subject accounts correspond to the energy-saving information; calculating a plurality of difficulty levels of the energy-saving information based on the feedback records of the subject accounts; and selecting the recommended energy-saving information from the energy-saving information based on the user level of the user account and the difficulty levels of the energy-saving information.

In some embodiments, the energy-saving information providing apparatus 1 selects the energy-saving information according to the following order of priority. First, the energy-saving information providing apparatus 1 selects (1) the energy-saving information has been implemented by the similar account but has not been implemented by the user account. If there is no energy-saving information meeting the condition (1), the energy-saving information providing apparatus 1 then selects (2) the energy-saving information has been sent to the similar accounts and has not been implemented by the user account. If there is no energy-saving information meeting the conditions (1) and (2), the energy-saving information providing apparatus 1 then selects (3) the energy-saving information that matches the user level of the user account and has not been implemented by the user account.

Finally, through the selection in the operation OP7, the energy-saving information providing apparatus 1 is able to generate the recommended energy-saving information for sending to the apparatus corresponding to the user account or sending it to the user account directly.

In some embodiments, the energy-saving information providing apparatus 1 provides a user interface to disseminate the energy-saving information. For example, the energy-saving information providing apparatus 1 displays the recommended energy-saving information disseminated by an application on a display screen.

In some embodiments, after disseminating the recommended energy-saving information, the energy-saving information providing apparatus 1 further investigates whether the user implements the recommended energy-saving information, and the user may provide feedback via the user interface. Accordingly, the energy-saving information providing apparatus 1 is able to update the feedback record of the user account based on the feedback inputted by the user and takes the feedback as a reference for future dissemination. For example, the energy-saving information providing apparatus 1 will not disseminate the energy-saving information that has already been implemented by the user account.

Specifically, the processor 12 is further configured to execute the following operations: obtaining an input feedback corresponding to the recommended energy-saving information of the user account; and updating the feedback record of the user account based on the input feedback.

In some embodiments, the energy-saving information providing apparatus 1 disseminates the recommended energy-saving information to the user account periodically through the aforementioned operations, e.g., sending the recommended energy-saving information once per week. On the other hand, the energy-saving information providing apparatus 1 also disseminates the recommended energy-saving information to the user account when a specific condition is triggered. For example, when there is an abnormal increase in electric consumption of the user account, the energy-saving information providing apparatus 1 reminds the user account to check the electrical appliances.

Specifically, the processor 12 is further configured to execute the following operation: in response to a real-time energy usage information of the user account matching a trigger condition, selecting a piece of real-time energy-saving information from the energy-saving information based on the trigger condition and sending the real-time energy-saving information to the user account.

In summary, the energy-saving information providing apparatus 1 in the present disclosure selects other similar account based on the energy usage record of the user account and selects and disseminates the recommended energy-saving information based on the energy usage feedbacks of the user account and the similar accounts. Additionally, by establishing difficulty scale according to feedback from the accounts, the energy-saving information providing apparatus 1 is able to level the energy-saving information and further disseminate energy-saving information that better meets the user’s needs. Therefore, the energy-saving information providing apparatus 1 is able to disseminate the energy-saving information more precisely by referring to the implementation difficulty of the energy-saving information and the account data with similar energy usage to the user account.

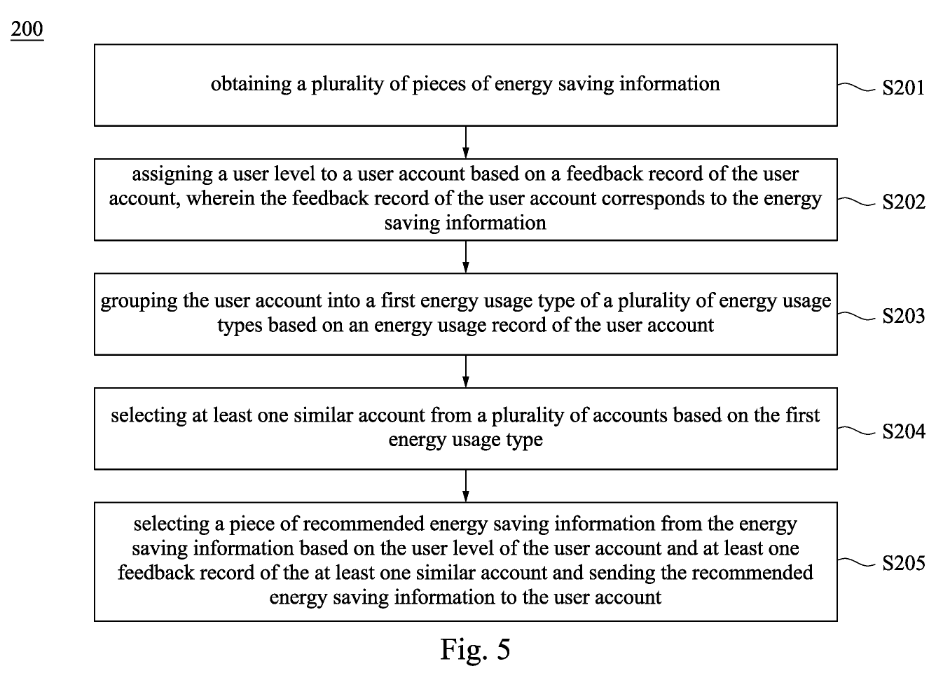

Please refer to FIG. 5, which is a flow diagram illustrating an energy-saving information providing method 200 according to a second embodiment of the present disclosure. The energy-saving information providing method 200 comprises steps S201-S205. The energy-saving information providing method 200 is configured to send recommended energy-saving information based on energy usage records and feedback from a user account. The energy-saving information providing method 200 can be executed by an electronic apparatus (e.g., the energy-saving information providing apparatus 1 in the first embodiment).

First, in the step S201, the electronic apparatus obtains a plurality of pieces of energy-saving information.

Next, in the step S202, the electronic apparatus assigns a user level to a user account based on a feedback record of the user account, wherein the feedback record of the user account corresponds to the energy-saving information.

Next, in the step S203, the electronic apparatus groups the user account into a first energy usage type from a plurality of energy usage types based on an energy usage record of the user account.

Next, in the step S204, the electronic apparatus selects at least one similar account from a plurality of accounts based on the first energy usage type.

Finally, in the step S205, the electronic apparatus selects a piece of recommended energy-saving information from the energy-saving information based on the user level of the user account and at least one feedback record of the at least one similar account and sending the recommended energy-saving information to the user account.

In some embodiments, the feedback record of the user account comprises at least one piece of implemented information the user account has implemented among the energy-saving information, and the step S202 further comprises the electronic apparatus calculating a score for the user account based on at least one difficulty level corresponding to the implemented information; and the electronic apparatus determining the user level of the user account based on the score.

In some embodiments, the step S203 further comprises the electronic apparatus selecting a first energy usage group from a plurality of energy usage groups based on a total energy consumption of the user account; and the electronic apparatus grouping the user account into the first energy usage type based on a plurality of energy consumptions of the user account corresponding to a plurality of time points, wherein the first energy usage type corresponding to the first energy usage group.

In some embodiments, the step of selecting the first energy usage group further comprises the electronic apparatus grouping the user account and the accounts into a high energy usage group and a low energy usage group based on the total energy consumption of the user account and a plurality of total energy consumptions of the accounts to generate a first grouping result; and the electronic apparatus selecting the first energy usage group based on the first grouping result.

In some embodiments, the step of grouping the user account into the first energy usage type further comprises the electronic apparatus grouping the user account and the accounts in the first energy usage group into a plurality of feature groups based on the energy consumptions of the user account and a plurality of energy consumptions of the accounts in the first energy usage group corresponding to the time points to generate a second grouping result; and the electronic apparatus selecting the first energy usage type from the energy usage types corresponding to the first energy usage group based on the second grouping result.

In some embodiments, the step S204 further comprises the electronic apparatus selecting at least one first account corresponding to the first energy usage type from the accounts; the electronic apparatus then selecting the at least one similar account from the at least one first account based on a level range corresponding to the user level of the user account.

In some embodiments, the step S205 further comprises the electronic apparatus filtering out at least one piece of implemented information that the user account has implemented from the energy-saving information; and the electronic apparatus selecting a piece of implemented information the at least one similar account has implemented from the filtered energy-saving information to identify the recommended energy-saving information.

In some embodiments, the step S205 further comprises the electronic apparatus receiving a plurality of feedback records of a plurality of subject accounts, wherein the feedback records of the subject accounts correspond to the energy-saving information; the electronic apparatus calculates a plurality of difficulty levels of the energy-saving information based on the feedback records of the subject accounts; and the electronic apparatus selects the recommended energy-saving information from the energy-saving information based on the user level of the user account and the calculated difficulty levels of the energy-saving information.

In some embodiments, the energy-saving information providing method 200 further comprises, in response to a real-time energy usage information of the user account matching a trigger condition, the electronic apparatus selecting a piece of real-time energy-saving information from the energy-saving information based on the trigger condition and sending the real-time energy-saving information to the user account.

In some embodiments, the energy-saving information providing method 200 further comprises the electronic apparatus obtaining an input feedback corresponding to the recommended energy-saving information of the user account; and the electronic apparatus updating the feedback record of the user account based on the input feedback.

In summary, the energy-saving information providing method 200 in the present disclosure selects other similar accounts based on the energy usage record of the user account and selects and disseminates the recommended energy-saving information based on the energy usage feedbacks of the user account and the similar accounts. Additionally, by establishing difficulty scale according to feedback from the accounts, the energy-saving information providing method 200 is able to categorize the energy-saving information and further disseminate options of information that better meets the user’s needs. Therefore, the energy-saving information providing method 200 is able to disseminate the energy-saving information more precisely by referring to the implementation difficulty of the energy-saving information and the account data with similar energy usage to that of the user account.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. An energy-saving information providing apparatus, comprising:
a storage, configured to store a plurality of pieces of energy-saving information; and
a processor, coupled to the storage, and configured to execute the following operations:
assigning a user level to a user account based on a feedback record of the user account, wherein the feedback record of the user account corresponds to the energy-saving information;
grouping the user account into a first energy usage type from a plurality of energy usage types based on an energy usage record of the user account;
selecting at least one similar account from a plurality of accounts based on the first energy usage type; and
selecting a piece of recommended energy-saving information from the energy-saving information based on the user level of the user account and at least one feedback record of the at least one similar account, and sending the recommended energy-saving information to the user account.

2. The energy-saving information providing apparatus of claim 1, wherein the feedback record of the user account comprises at least one piece of implemented information the user account has implemented among the energy-saving information, and the operation of assigning the user level to the user account further comprises:
calculating a score of the user account based on at least one difficulty level corresponding to the implemented information; and
determining the user level of the user account based on the score.

3. The energy-saving information providing apparatus of claim 1, wherein the operation of grouping the user account into the first energy usage type further comprises:
selecting a first energy usage group from a plurality of energy usage groups based on a total energy consumption of the user account; and
grouping the user account into the first energy usage type based on a plurality of energy consumptions of the user account corresponding to a plurality of time points, wherein the first energy usage type corresponds to the first energy usage group.

4. The energy-saving information providing apparatus of claim 3, wherein the operation of selecting the first energy usage group further comprises:
grouping the user account and the accounts into a high energy usage group and a low energy usage group based on the total energy consumption of the user account and a plurality of total energy consumptions of the accounts to generate a first grouping result; and
selecting the first energy usage group based on the first grouping result.

5. The energy-saving information providing apparatus of claim 3, wherein the operation of grouping the user account into the first energy usage type further comprises:
grouping the user account and the accounts in the first energy usage group into a plurality of feature groups based on the energy consumptions of the user account and a plurality of energy consumptions of the accounts in the first energy usage group corresponding to the time points to generate a second grouping result; and
selecting the first energy usage type from the energy usage types corresponding to the first energy usage group based on the second grouping result.

6. The energy-saving information providing apparatus of claim 1, wherein the operation of selecting the at least one similar account further comprises:
selecting at least one first account corresponding to the first energy usage type from the accounts; and
selecting the at least one similar account from the at least one first account based on a level range corresponds to the user level of the user account.

7. The energy-saving information providing apparatus of claim 1, wherein the operation of selecting the recommended energy-saving information further comprises:
filtering out at least one piece of implemented information the user account has implemented from the energy-saving information; and
selecting a piece of implemented information the at least one similar account has implemented from the filtered energy-saving information to determine the recommended energy-saving information.

8. The energy-saving information providing apparatus of claim 1, wherein the operation of selecting the recommended energy-saving information further comprises:
receiving a plurality of feedback records of a plurality of subject accounts, wherein the feedback records of the subject accounts correspond to the energy-saving information;
calculating a plurality of difficulty levels of the energy-saving information based on the feedback records of the subject accounts; and
selecting the recommended energy-saving information from the energy-saving information based on the user level of the user account and the difficulty levels of the energy-saving information.

9. The energy-saving information providing apparatus of claim 1, wherein the processor is further configured to execute the following operation:
in response to a real-time energy usage information of the user account matching a trigger condition, selecting a piece of real-time energy-saving information from the energy-saving information based on the trigger condition and sending the real-time energy-saving information to the user account.

10. The energy-saving information providing apparatus of claim 1, wherein the processor is further configured to execute the following operations:
obtaining an input feedback corresponding to the recommended energy-saving information of the user account; and
updating the feedback record of the user account based on the input feedback.

11. An energy-saving information providing method adapted for use in an electronic apparatus, wherein the energy-saving information providing method comprises the following steps:
obtaining a plurality of pieces of energy-saving information;
assigning a user level to a user account based on a feedback record of the user account, wherein the feedback record of the user account corresponds to the energy-saving information;
grouping the user account into a first energy usage type of a plurality of energy usage types based on an energy usage record of the user account;
selecting at least one similar account from a plurality of accounts based on the first energy usage type; and
selecting a piece of recommended energy-saving information from the energy-saving information based on the user level of the user account and at least one feedback record of the at least one similar account, and sending the recommended energy-saving information to the user account.

12. The energy-saving information providing method of claim 11, wherein the feedback record of the user account comprises at least one piece of implemented information the user account has implemented among the energy-saving information, and the step of assigning the user level to the user account further comprises:
calculating a score of the user account based on at least one difficulty level corresponding to the implemented information; and
determining the user level of the user account based on the score.

13. The energy-saving information providing method of claim 11, wherein the step of grouping the user account into the first energy usage type further comprises:
selecting a first energy usage group from a plurality of energy usage groups based on a total energy consumption of the user account; and
grouping the user account into the first energy usage type based on a plurality of energy consumptions of the user account corresponding to a plurality of time points, wherein the first energy usage type corresponding to the first energy usage group.

14. The energy-saving information providing method of claim 13, wherein the step of selecting the first energy usage group further comprises:
grouping the user account and the accounts into a high energy usage group and a low energy usage group based on the total energy consumption of the user account and a plurality of total energy consumptions of the accounts to generate a first grouping result; and
selecting the first energy usage group based on the first grouping result.

15. The energy-saving information providing method of claim 13, wherein the step of grouping the user account into the first energy usage type further comprises:
grouping the user account and the accounts in the first energy usage group into a plurality of feature groups based on the energy consumptions of the user account and a plurality of energy consumptions of the accounts in the first energy usage group corresponding to the time points to generate a second grouping result; and
selecting the first energy usage type from the energy usage types corresponding to the first energy usage group based on the second grouping result.

16. The energy-saving information providing method of claim 11, wherein the step of selecting the at least one similar account further comprises:
selecting at least one first account corresponding to the first energy usage type from the accounts; and
selecting the at least one similar account from the at least one first account based on a level range corresponding to the user level of the user account.

17. The energy-saving information providing method of claim 11, wherein the step of selecting the recommended energy-saving information further comprises:
filtering out at least one piece of implemented information the user account has implemented from the energy-saving information; and
selecting a piece of implemented information that the at least one similar account has implemented from the filtered energy-saving information to select the recommended energy-saving information.

18. The energy-saving information providing method of claim 11, wherein the step of selecting the recommended energy-saving information further comprises:
receiving a plurality of feedback records of a plurality of subject accounts, wherein the feedback records of the subject accounts correspond to the energy-saving information;
calculating a plurality of difficulty levels of the energy-saving information based on the feedback records of the subject accounts; and
selecting the recommended energy-saving information from the energy-saving information based on the user level of the user account and the difficulty levels of the energy-saving information.

19. The energy-saving information providing method of claim 11, further comprising:
in response to a real-time energy usage information of the user account matching a trigger condition, selecting a piece of real-time energy-saving information from the energy-saving information based on the trigger condition and sending the real-time energy-saving information to the user account.

20. The energy-saving information providing method of claim 11, further comprising:
obtaining an input feedback corresponding to the recommended energy-saving information of the user account; and
updating the feedback record of the user account based on the input feedback.
